(19) United States
(12) Patent Application Publication
(10) Pub. No.: US 2010/0139038 A1
(43) Pub. Date: Jun. 10, 2010

(54) Suspension System for Sliding Doors

(75) Inventor: Sven Busch, Dortmund (DE)

Correspondence Address: COHEN, PONTANI, LIEBERMAN & PAVANE LLP, 551 FIFTH AVENUE, SUITE 1210, NEW YORK, NY, 10176, US

(73) Assignee: Domma GmbH + Co KG, Ennepetal (DE)

(21) Appl. No.: 12/673,738

(22) PCT Filed: Jul. 30, 2008
(86) PCT No.: PCT/EP08/06272

§ 371 Date: Feb. 16, 2010

(30) Foreign Application Priority Data
Aug. 16, 2007 (DE) 102007038842.1

(51) Int. Cl. E05D 15/06; E05D 15/00; E06B 3/34

(52) U.S. Cl. 16/90; 16/91; 49/427; 49/381

(57) ABSTRACT

A suspension system for at least one panel movable along a travel path is disclosed. The suspension system has at least two carriages for the at least one movable panel. The at least two carriages are stationarily mounted at an upper section of the at least one movable panel and are disposed to extend essentially in a direction transversely to the travel path and parallel to a vertical extension of the at least one movable panel. Rollers are freely rotatably disposed at each carriage. The rollers are disposed to roll on a running surface of a running rail of the suspension.

### PRIORITY CLAIM

This is a U.S. national stage of application No. PCT/EP2008/006272, filed on Jul. 30, 2008 which claims priority to the German Application No.: 10 2007 038 842.1, filed: Aug. 16, 2007, the content of both incorporated herein by reference.

### BACKGROUND OF THE INVENTION

1. Field of the Invention

The invention relates to a suspension system for sliding doors, in particular for all-glass sliding door leaves.

2. Related Art

Suspension systems for sliding doors based on rollers and/or on a magnetic carrying device are known.

In suspension systems for sliding doors based exclusively on rollers, a respective sliding door leaf is usually suspended from two carriages. Seen horizontally in a travel direction of the sliding door leaf, rollers are freely rotatably disposed at the sides. At least two rollers, disposed at opposite sides of one carriage, roll in this case on running surfaces of running rails, wherein the running surfaces point in one and the same vertical direction. This means, two rollers roll respectively on a lower or respectively on an upper running rail.

One disadvantage results from an unfavourable mounting of such a sliding door leaf. The carriages need to be introduced, respectively into the running rails from a front side. Then, the sliding door leaf needs to be attached to the carriage. Therefore, it is required to bring the sliding door leaf into a suspending position and to maintain it therein, until it is mounted to the carriage, a circumstance that makes mounting more complicated and, particularly with all-glass sliding door leaves, involves the risk of damage.

Another disadvantage is the multitude of required running rails and rollers, which results in a higher friction resistance and thus in higher expenditure of forces for displacing such suspended sliding door leaves. This is in particular relevant with automatic sliding door installations from an energy efficiency point of view.

Rollers are foregone in exclusively magnetic suspension systems for sliding doors, which makes mounting easier and reduces the friction resistance to a minimum. However, the exclusively magnetic suspension system for sliding doors is very unpractical. It is almost impossible to maintain the sliding door leaf in an ideal position in each condition. In particular during the initial acceleration of such a sliding door leaf, forces are generated in a direction transversely to the travel direction of the respective sliding door leaf. These forces comprise for example inertia of the respective sliding door leaf, which may cause rolling motions in the sliding door leaf, and wind forces, which may act at an angle, for example vertically on a lateral surface of the sliding door leaf. It is very difficult to compensate for these forces.

Moreover, suspension systems for sliding doors are known, which are a combination of the above mentioned suspension systems for sliding doors. They have a magnetic carrying system for sliding door leaves, i.e. the sliding door leaves, like in the above described exclusively magnetic suspension systems for sliding doors, are suspended by magnetic force. However, the respective sliding door leaves are again as usual provided with two carriages, at which, seen horizontally in travel direction, rollers are freely rotatably disposed at the sides. In this case, the rollers of a respective carriage roll respectively on an upper running rail. A predetermined distance, between carriage, respectively sliding door leaf and usually utilized magnets, is guaranteed thereby, such that the sliding door leaf can always be reliably displaced. Thereby the above described transverse forces, acting on the sliding door leaf, can be compensated for. However, this type of suspension system for sliding doors has the disadvantage that the magnetic force of attraction between the magnet and the carriage, respectively the sliding door leaf needs to be at least slightly larger than a weight force of the sliding door leaf including its carriages.

### SUMMARY OF THE INVENTION

Therefore, an object of the invention is to provide a suspension system for sliding doors in which disadvantages of the state-of-the-art are at least reduced.

An inventive suspension system for at least one panel movable along a travel path has at least two carriages for the at least one movable panel. The at least one movable panel may be a sliding door leaf, a circular sliding door leaf, a curved sliding door leaf, a folding door leaf, a revolving door leaf or the like. The at least two carriages are stationarily attached at an upper section of this movable panel. In addition, they are disposed to extend essentially in a direction transversely to the travel path and parallel to a vertical extension of this panel. Rollers are freely rotatably disposed at each carriage such that their axes of rotation extend transversely to the travel path and transversely to the vertical extension of this panel. The rollers are disposed to roll on a running surface of a running rail of the suspension system. The running rail extends along at least one portion of the travel path of the movable panel, and the running surface thereof points in a direction parallel to the vertical extension of this panel and away from it. The running surface points vertically to the top such that the rollers roll on the running rail thus disposed below them.

Thus, in such a suspension system there is only one running rail. The rollers, seen in a travel direction of the movable panel, are disposed at a side of the respective carriage. Thus, the rollers disposed at the opposite side of the carriage, as well as the associated running rail are eliminated, which results in cost savings and in reducing the friction resistance caused by the rollers. Furthermore, such a suspension system offers the advantage of a simple installation. Instead of introducing the carriages from a front side into the guiding rails and to attach them at the movable panel in a cumbersome manner, it is now possible to attach the carriages at the movable panel prior to placing them on the one running rail. Once the carriages are mounted, the at least one movable panel can be suspended from the front, i.e. seen in a direction transversely to the travel direction of the movable panel.

Preferably, the at least two carriages of the respective movable panel are configured such that this movable panel and the rollers of its carriage, seen in a direction parallel to the vertical extension of the movable panel, are disposed to be aligned. The rollers and the associated movable panel, seen in a travel direction, are disposed one below the other without having a lateral distance to each other. It is thereby possible that the movable panel does not generate any torque in the area of the rollers, which could cause the movable panel to tilt in the suspended condition. Therefore, there are no, or only very simple, inexpensive measures required to prevent the movable panel from tilting.

Preferably, the respective movable panel, with a lower section, is received in a guided and supported manner in a floor rail. This is a particularly simple possibility to prevent the respective movable panel from tilting.

In cross-section, the running surface of the running rail is preferably configured to be uneven. The rollers running on the running rail have a running surface which is configured to be complementary to the running rail surface. This measure counteracts derailing of the rollers. On account of the movable panel's own weight and of the uneven running surfaces in cross-section, moving the rollers away from the running rail can be at least made more difficult.

It is furthermore preferred the running rail has a contact section. The contact section extends parallel to the at least one running rail. In addition, this section is configured in that the rollers, rolling on the running rail, are supported with an upper section at the contact section at a surface facing the respective associated carriage. A configuration is thereby created to prevent the rollers from tilting. Furthermore, the contact section may assume a guiding function.

Preferably, the carriages of the movable panel each have one clamp mounting in which the movable panel is stationarily received. The movable panel is suspended by the clamp mountings. Thus, neither machining of the movable panel itself nor any precautions need to be taken to attach the carriages. This is in particular advantageous with all-glass installations. For example in a sliding door installation, the all-glass sliding door leaves can be manufactured in one piece, without, during the manufacturing process, having to take into consideration any through-openings or through-holes for mounting devices or without having to incorporate them afterwards in the sliding door leaf at some expense. Manufacturing costs are thereby saved. Another advantage is that, on account of the structural integrity of the sliding door leaf, at any time the sliding door leaf can be exchanged or used otherwise.

The clamp mountings are preferably U-shaped in cross-section, the U being open towards the movable panel. Furthermore, the clamp mountings have respectively one clamping jaw, which, by an adjusting device, can be brought into clamping engagement towards the associated movable panel and disposed thereon to be releasable. The clamp jaw clamps the movable panel. Such a disposition has a very simple structure.

The adjusting device preferably comprises a screw by which the clamping jaw is movable towards the movable panel and away from it. This disposition allows for a simple exchange of the parts of the adjusting device, namely screw and clamping jaws.

Preferably with an end facing away from a head of the screw, the screw is supported at the respective clamping jaw. The screw is screwed into a female thread section of a leg of the U-shaped profile. In this case, the clamping jaw is disposed between this leg and the movable panel.

This leg of the U-shaped profile preferably has a projection, which extends from a free end of this leg towards the movable panel. In this case, while preferably passing through a through-opening configured in the projection, the screw is screwed into a contact member. The contact member has an oblique surface at a side facing the movable panel. This oblique extending surface is slanted in the direction of the head of the screw such that the contact member tapers towards the head of the screw. At a side facing the contact member, the clamping jaw has an oblique surface configured complementary to the oblique surface of the contact member. It is with this oblique surface that the contact member comes to lie at the clamping jaw. The oblique surfaces increase the expenditure of forces which is necessary to release the clamping jaw from the movable panel. This enhances the safety, when clamping the movable panel.

As an alternative, the oblique surface of the clamping jaw may be configured slanted in the direction of the head of the screw such that the clamping jaw tapers towards the head of the screw.

### BRIEF DESCRIPTION OF DRAWINGS

Further features and advantages of the invention will become apparent from the following description of preferred embodiments, in which:

FIGS. 1 to 8: are suspension systems according to different embodiments of the invention.

### DETAILED DESCRIPTION OF THE PREFERRED EMBODIMENTS

A suspension system, according to a first embodiment of the invention illustrated in FIG. 1, comprising a panel, in the shape of a sliding door leaf 1, movable along a travel path. The sliding door leaf 1 is mounted to preferably two carriages 2. At each carriage 2, seen in the travel direction of the sliding door leaf 1, namely in ±x-coordinate direction in FIG. 1, at least one roller 7 is freely rotatably disposed at a left side according to FIG. 1.

The roller 7 is disposed such as to roll with a section of its running surface pointing downwards, i.e. in −y-coordinate direction, on a running surface 9 of a running rail 8. The running surface 9 is pointing upwards, i.e. in y-coordinate direction in FIG. 1. Thus the running rail 8 serves for absorbing the weight force of all sliding door leaves 1 guided thereon, including the carriages 2 thereof.

The running rail 8 may be configured separately, may be incorporated into a carrying profile 3, or may be configured integrally with the latter, as illustrated in FIG. 1.

The sliding door leaf 1 is preferably attached by clamping at the respective carriage 2. For this purpose, at least in an area for the reception of the sliding door leaf 1, the respective carriage 2 is configured in the shape of a U open to the bottom, i.e. in −y-coordinate direction in FIG. 1. A reception space is created by means of this U for the components of a clamp mounting and of an upper section of the respective sliding door leaf 1 to be clamped.

The clamp mounting essentially comprises a clamping jaw 5, which, preferably by an adjusting screw 4, can be brought into clamping engagement towards the respective sliding door leaf 1 and, by moving away from the sliding door leaf 1, can be released from the sliding door leaf 1.

Preferably, from the outside with regard to the carriage 2, the screw 4 is screwed into a female thread, which is configured in one leg of the carriage 2. At an end, distant from a head of the screw 4, the screw 4 is supported at the clamping jaw 5. When rotating, respectively turning the screw 4, the end of the screw 4, distant with regard to the head, and thus the clamping jaw 5 are translationally moved towards, respectively away from the sliding door leaf 1.

During the clamping action, the clamping jaw 5 presses the sliding door leaf 1 preferably against an inner surface of a leg of the carriage 2 opposite the one leg of the carriage 2. This other leg is disposed at a side of the sliding door leaf 1 facing away from the clamping jaw 5. Clamp linings 6 are mounted preferably at the said leg of the carriage 2 as well as at the clamping jaw 5 in contact areas, respectively in clamping areas with the sliding door leaf 1. It is thereby possible to build the respective carriage 2 and the associated clamping jaw 5 from a relatively hard material, whereas the clamp lining 6 may have certain flexibility and may be made from an elastic material. Damages, such as scratches, can be avoided at an all-glass sliding door leaf 1, or at least scratching in said clamping areas is made more difficult.

On account of the sliding door leaf 1 being suspended at one side only, a torque is generated by means of the sliding door leaf 1 which acts at a lower end of the sliding door leaf 1 towards the left side in FIG. 1. Preferably a floor guide is therefore provided, in order to prevent the unilaterally suspended sliding door leaf 1 from tilting.

In the embodiment illustrated in FIG. 1, the floor guide comprises at least one guiding roller 14, which is guided in a floor rail 15, which extends along the travel path of the sliding door leaf 1. The guiding roller 14 guides the sliding door leaf 1 in a direction transversely to the travel direction, i.e. in ±z-coordinate direction in FIG. 1.

In the example shown, the guiding roller 14 is received freely rotatably supported in the sliding door leaf 1. As can be seen, the guiding roller 14 has preferably a distance to the floor rail 15 in a central section 14a, seen in x-coordinate direction in FIG. 1. This means, with its central section 14a, the guiding roller 14 does not roll on a running surface of the floor rail.

On account of the leverage effect, the floor guide only has to absorb a fraction of a torque generated on account of a weight force of the sliding door leaf 1, which torque is applied in the area of the roller(s) 7. This is why it is possible in this case to utilize running materials that run smoother than those for the roller(s) 7.

As an alternative or in addition, the at least one guiding roller 14 is resiliently supported with regard to the sliding door leaf 1. Therefore, unevenness across the travel path of the sliding door leaf 1 can be compensated for. In addition, a portion of the weight force of the sliding door leaf 1 and of the associated carriages 2 can thereby be absorbed by the guiding roller 14. This results in a relief for the rollers 7 and for the associated running rail 8. This in turn translates into cost advantages, because of lower rigidity requirements, more inexpensive material and/or less material can be utilized, because the dimensions of the running rail 8, transversely to its longitudinal extension can be made smaller.

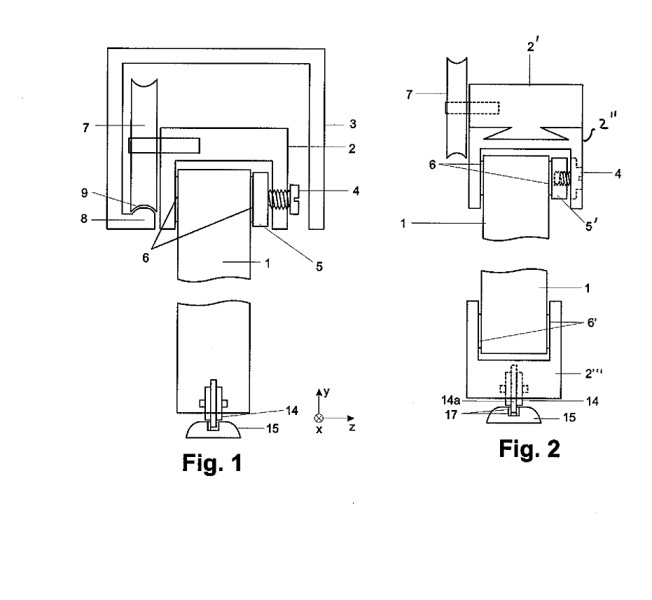

In a suspension system according to a second embodiment of the invention illustrated in FIG. 2, the carriage is configured in two components. An upper component 2′ is provided for the support of at least one roller 7. A lower component 2″ is provided for clamping and mounting a sliding door leaf 1. Both components of the carriage 2′, 2″ are preferably slipped onto each other by means of a dovetail guide. The weight force of the suspended sliding door leaf 1 prevents the components from mutual shifting. In addition they may be provided with a surface which effects a higher adhesive friction between them. Obviously, the components of the carriage 2′, 2″ can be stationarily mounted to each other by any other type of attachment, for example by attachment screws.

Unlike in the embodiment shown in FIG. 1, the screw 4 is not supported at the clamping jaw 5 and screwed into a female thread section in the carriage 2. The screw 4 is screwed into a female thread configured in the clamping jaw 5. The head of the screw 4 is formed such that it is supported at a surface of an associated leg of the carriage 2 facing the clamping jaw 5′, such that, when rotated, the screw 4 maintains its position with regard to the carriage 2. When rotated, the screw 4 is screwed into the clamping jaw, respectively unscrewed from it, which translates into a corresponding translational movement of the clamping jaw away from the sliding door leaf 1, respectively towards the latter. The leg has preferably a recess, which is configured such that the head of the screw 4 is received at least partially, and can be freely rotated in the recess.

The at least one guiding roller 14 is freely rotatably received in a carriage 2′, which is preferably clamped onto a lower section of the sliding door leaf 1. An adjusting screw can be foregone, because such a clamp mounting does not have to develop important holding forces. The holding forces are minimally high so that the carriage 2′″ does not change its position with regard to the sliding door leaf 1. In cross-section, the carriage 2′ is preferably configured U-shaped, wherein the U is open to the top. In contact areas, or clamping areas with the sliding door leaf 1, respectively one clamp lining 6′ can be provided.

Guiding linings 17 are provided in the floor rail 15 in this embodiment, which linings sit close laterally at the central section 14a of the at least one guiding roller 14 and are preferably made from a material which is favourable for gliding.

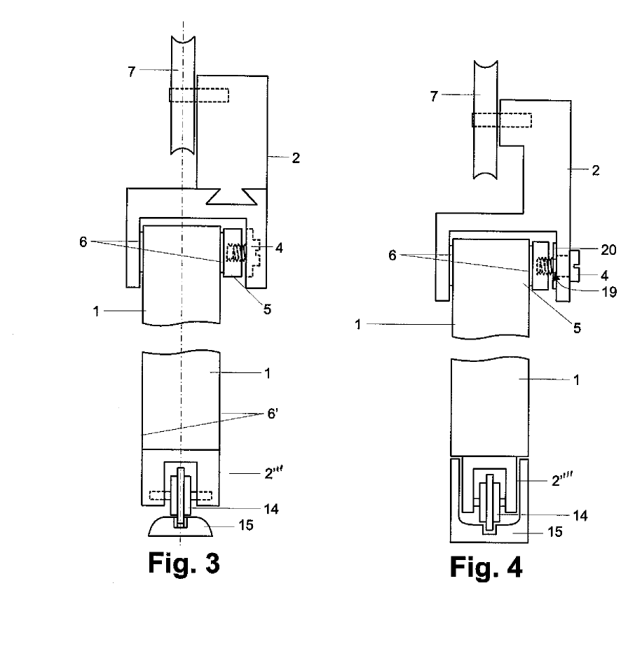

In a suspension system according to a third embodiment of the invention illustrated in FIG. 3, the carriage 2 is configured such that in FIG. 3 a vertical central line of the at least one roller 7 coincides with a vertical central line of the sliding door leaf 1, illustrated by a dash-dotted line in FIG. 3. Therefore, in the area of the roller, the sliding door leaf 1 merely generates a torque, or no torque at all, about an axis parallel to the travel path of the sliding door leaf 1. For this reason, under certain circumstances, a guide for the sliding door leaf 1 in a floor area of the sliding door leaf 1 can be foregone.

Like in the second embodiment of the invention, the carriage 2′″ has a U-shaped cross-section, except that this time, the U is configured open to the bottom, i.e. in the direction of the floor rail 15. The carriage 2′″ is stationarily mounted to the sliding door leaf 1 by means of glueing or any other attachment type, for example by latching or attachment screws.

In a suspension system according to a fourth embodiment of the invention illustrated in FIG. 4, with a surface of its head facing the clamping jaw 5, the screw 4 is supported at a side of the leg of the carriage 2″″, side pointing to the outside. At an opposite side of the leg, pointing to the inside, a securing device is provided that prevents the screw 4 from falling out of the leg. The securing device is preferably formed by a retaining ring 20. The retaining ring 20 is fitted onto a groove 19, which is configured at the circumference of the screw 4.

Preferably, the carriage 2″″ has a width, which is smaller than a width of the sliding door leaf 1. Laterally, the floor rail 15 has two legs, which are configured to extend in the direction of the sliding door leaf 1. A width of the floor rail 15 preferably corresponds to a width of the sliding door leaf 1 such that, seen in travel direction of the sliding door leaf 1, the legs are flush with a respective lateral surface. Preferably at front surfaces of the legs facing the sliding door leaf 1, seals are respectively provided, for example in the shape of non-illustrated brushes, which make it more difficult for impurities to penetrate into the floor rail 15.

In the area of the roller 7, in cross-section, the carriage 2 is configured as a horizontal U, wherein the U is open in the direction of rollers 7. The inner space of the U offers more space for a non-illustrated running rail 8.

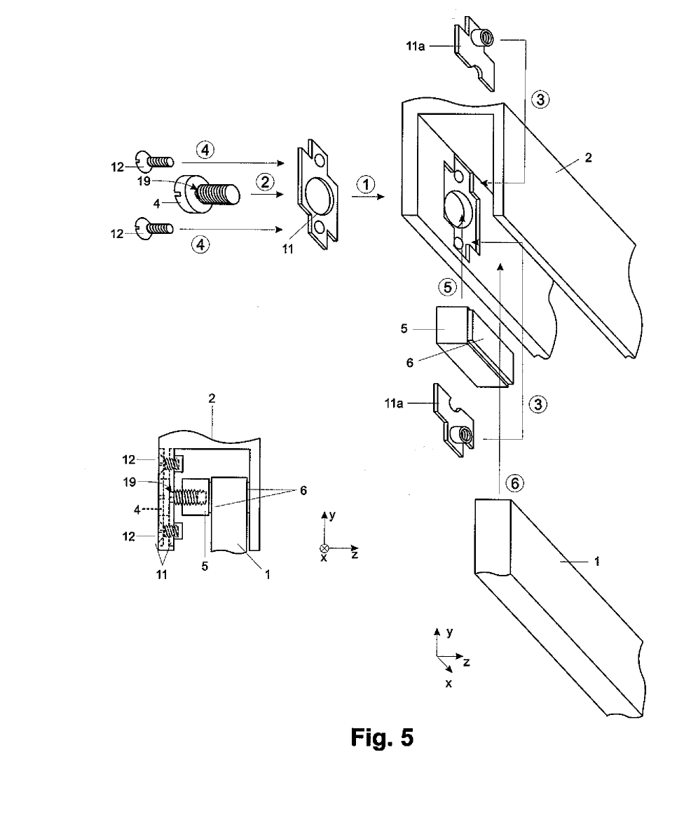

FIG. 5 shows a suspension system according to a fifth embodiment of the invention. According to FIG. 5, the head of the screw 4 is received in a recess configured in a leg of the carriage 2. The recess has preferably the shape of a circular through-opening with a diameter so large that, with its head, the screw 4 can be freely rotated in the through-opening. A first attachment member 11, illustrated on the right side in FIG. 5, assumes the function of the retaining ring. The first attachment member 11 consists of two halves 11a, 11a, which, at sides facing each other, have respectively one portion of a through-opening. If the two halves 11a, 11a are assembled, they result in a through-opening, which is configured complementary to the groove 19 of the screw 4. With the first attachment member 11 mounted, the screw 4 is received in the carriage 2 without the risk of being lost.

Seen in ±z-coordinate direction, the halves 11a, 11a have a non-circular exterior contour. It is furthermore preferred they are each equipped with a bushing with a female thread. The carriage 2 has preferably a recess, which has an interior contour complementary to an exterior contour of the assembled halves 11a, 11a.

At an outer side of the leg of the carriage 2, preferably a second attachment member 11 is inserted, namely preferably again in a recess configured in the leg.

The second attachment member 11 has a through-opening preferably in the center analogously to the through-opening in the leg of the carriage 2, such that the screw 4 is likewise freely rotatably disposed in this through-opening.

It is furthermore preferred, the second attachment member 11, as well as the leg of the carriage 2 have through-openings, which are configured such that, in an installed condition of the attachment members 11, 11a, 11b they are disposed aligned with a respective bushing of one of the halves 11a, 11a. Attachment screws 12 are screwed tight, through the through-openings of the second attachment member 11 and of the leg, to a bushing of a respective half 11a. This allows for a simple installation.

The second attachment member 11a, 11b may be likewise foregone. In this case, the leg of the carriage 2 needs to have the required stability for mounting the screw 4 and the attachment screws 12.

After mounting the screw 4, the latter is simply screwed into the clamping jaw 5 and the clamp mounting is complete.

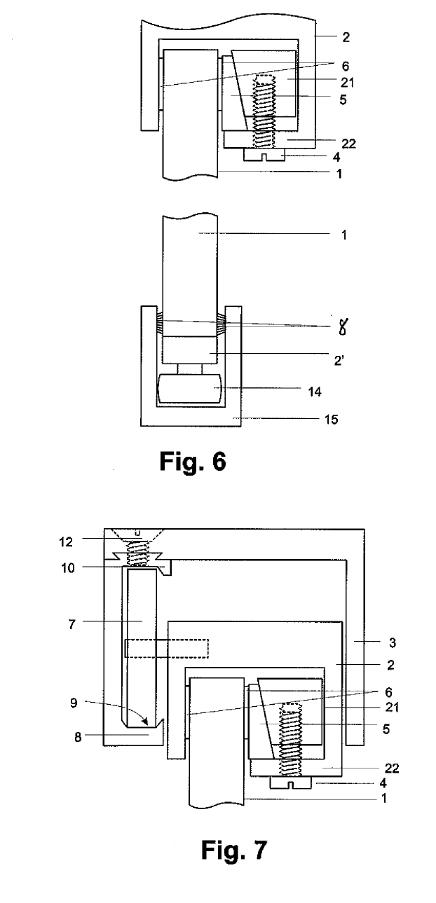

A suspension system according to a sixth embodiment of the invention is illustrated in FIG. 6.

The leg of the carriage 2, on the side of which the clamping jaw 5 is disposed, has a projection 22 at its free end. The projection 22 protrudes from said leg essentially vertically in the direction of the sliding door leaf 1. The projection 22 has a through-opening, which is configured to extend in vertical direction in FIG. 6. The screw 4 passes through the through-opening of the projection 22 from an outer side of the projection 22 and is screwed into a female thread configured in a contact member 21. A surface of the head of the screw 4 facing the projection 22 is preferably supported at the projection 22 itself.

The contact member 21 has an oblique surface at a side facing the clamping jaw 5. This oblique extending surface is configured slanted in the direction of the head of the screw 4 such that the contact member 21 tapers towards the head. At a side facing the contact member 21, the clamping jaw 5 has an oblique surface configured complementary to the oblique surface of the contact member 21. The contact member 21 will come to bear with its oblique surface against the oblique surface of the clamping jaw 5.

With an underside, the clamping jaw 5 is supported on a surface of the projection 22 facing the clamping jaw 5. Now, if the screw 4 is screwed into the contact member 21, the contact member 21 is moved downwards in FIG. 6. On account of the oblique contact surfaces, the contact member 21 urges the clamping jaw 5 in the direction of the sliding door leaf 1, whereby the clamping jaw 5 reaches clamping engagement with the sliding door leaf 1.

As already explained above, the weight of the sliding door leaf 1 and of associated carriages 2 is preferably absorbed by means of rollers 7 and a running rail 8. Based on the above, according to FIG. 6, at least two horizontally freely rotatably disposed guiding rollers 14 are provided in the floor guide.

The guiding rollers 14 are respectively received freely rotatably supported in a carriage 2′ and preferably have a crowned running surface in cross-section. Therefore, canting of the guiding rollers 14 in the floor rail 15 is hardly possible.

The one or more carriages 2′ is/are attached at the sliding door leaf 1 for example by means of glueing.

The guiding rollers 14 are supported at one of two vertically extending inner surfaces of the floor rail 15. The guiding rollers 14 have a maximum exterior diameter, which is at least slightly smaller than a distance of the inner surfaces of the floor rail 15 towards each other. It is thereby guaranteed that the guiding rollers 14 respectively roll on only one inner surface of the floor rail 15.

In cross-section, the floor rail 15 is preferably configured U-shaped, wherein the U is open to the top. In an area of ends of the legs of the carriage 2′, preferably at sides facing each other, seals are provided, for example in the shape of a respective brush arrangement 18. The brush arrangements 18 constitute a protection for the floor rail 15 against impurities.

FIG. 7 shows a suspension system according to a seventh embodiment of the invention. In this suspension system, the carrying profile 3 is configured such that the running rail 8 is introduced into the carrying profile 3 by means of a dovetail guide and is fixed in its position by means of at least one attachment screw 12. However, it may be configured integrally with the carrying profile 3.

Furthermore, the running rail 8 comprises a guiding section 10, which prevents the sliding door leaf 1 from tilting. In case the running rail 8 is dimensionally stable enough, a floor guide may be foregone.

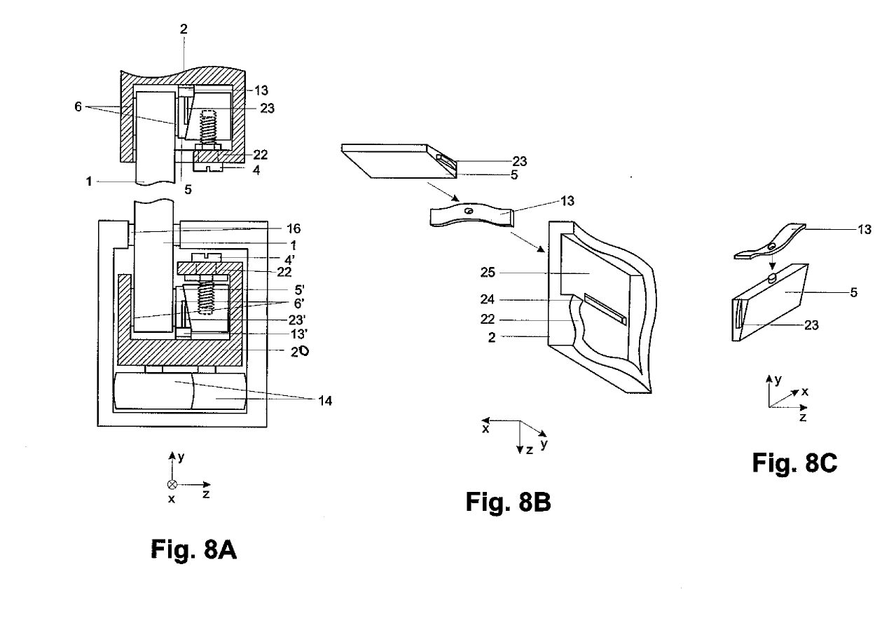

FIGS. 8A-8C show a suspension system according to an eighth embodiment of the invention. In this embodiment, compared to the seventh embodiment, the oblique surfaces extend mirror-inverted. This means, the oblique extending surface of the clamping jaw 5 is configured slanted in the direction of the head of the screw 4 such that it is now the clamping jaw 5 which tapers towards the head of the screw 4.

At the side, the clamping jaw 5 has preferably respectively one guiding projection 23. As can be particularly well seen in FIG. 8B, the guiding projection 23 is configured such that it extends from a lateral edge of a larger front face of the clamping jaw 5 in the direction of a narrower front face of the clamping jaw 5. Over its extension from the lateral edge, the respective guiding projection 23 preferably increases in cross-section. This increase may be linear, such that the guiding projection takes the shape of a ramp.

As an alternative, each guiding projection 23 has an arched shape as shown in FIGS. 8B and 8C. By means of its guiding projections 23 the clamping jaw 5 is in engagement with guiding grooves 24, which are configured in sidewall sections 25 of the carriage 2.

FIG. 8B shows one of two sidewall sections 25 of a carriage 2. The guiding grooves 24 extend vertically, i.e. in ±y-coordinate direction in FIG. 8B. Along a respective entire length, the guiding grooves 24 have preferably a constant depth. The lengths of the guiding grooves 24 are preferably equal or larger than a length of the respective corresponding guiding projection 23. Therefore, the clamping jaw 5 can move to a certain extent within the guiding grooves 24.

The guiding grooves 24 are not configured over an entire length of the respective inner surface of the associated sidewall section 25. According to FIG. 8B, they end behind the front edge of the respective inner surface of the associated sidewall section 25. In a terminal position of the clamping jaw 5, the guiding projections 23 with their front faces, pointing in −y-coordinate direction in FIG. 8, abut at one inner surface of the associated guiding grooves 24 facing the front surfaces. These inner surfaces thus limit the displacement path of the clamping jaw 5 in −y-coordinate direction, i.e. to the bottom in the FIGS. 8A and 8C. Thereby a reliable protection against falling out is provided for the clamping jaw 5.

With a front surface pointing to the top, the respective clamping jaw 5 is preferably supported at a spring element 13, which in turn is supported at an inner surface of the carriage 2 pointing to the bottom. As in particular illustrated in FIG. 8C, the spring element has a recess in the shape of preferably an oblong through-opening. At a side facing the spring element 13, the clamping jaw 5 has a fitting section configured complementary to the recess of the spring element 13. The fitting section is preferably dimensioned such that the spring element 13, when it is fitted onto the fitting section, reaches a clamping engagement with the latter.

In this case, the floor guide has carriages 20, which are essentially similar to the carriage 2 of FIG. 8A. Thus, they comprise clamping jaws 5′, which are preferably provided with guiding projections 23′ and are resiliently supported by means of spring elements 13′. Just the section for receiving the roller(s) 7 is omitted. Instead, guiding rollers 14 are freely rotatably disposed with regard to the carriage 20. The guiding rollers 14 are preferably disposed such that a portion thereof rolls on a vertically extending inner surface of the floor rail 15 and the other portion of the guiding rollers 14 rolls on another inner surface of the floor rail 15, which is opposite to the one inner surface of the floor rail 15, and likewise extends vertically.

At ends of its legs towards the sliding door leaf 1, the floor rail 15 has a seal, respectively in the shape of a sealing insert 16. The sealing insert may be formed for example by means of a foamed plastic.

The guiding rollers 14 are preferably supported in a pre-stressed manner at the inner surfaces of the floor rail 15. This means, in a non-inserted condition, the guiding rollers 14 have an overall width, which is preferably slightly larger than a distance of the inner surfaces of the floor rail 14 with regard to each other. In an inserted condition, this results in the circumstance that the carriage 20 is braced in the floor rail 15 such that it is reliably held in position in ±z-coordinate direction in FIG. 8A.

The carriages 2 and floor guides shown herein are exchangeable with each other or can be combined with each other.

Furthermore, each carriage 2 can be utilized as a carriage 20. Just the section for receiving the rollers 7 is omitted. Obviously the reverse is likewise possible.

Likewise, the above described non-resiliently supported clamping jaws 5 may be provided with a spring support.

The here described suspension systems may be provided with any type of linear drive. A drive based on traction means for example may be provided, wherein the carriage 2 may function as a driver together with the traction means, which may consist of a rope, a traction belt, a chain or the like. In case of a spindle drive as the linear drive, one of the carriages 2, or several carriages may have a threaded bushing, which is screwed onto the driving threaded spindle of the spindle drive. In case of a linear motor as the linear drive, at least one of the carriages may be provided with a row of magnets such that this carriage 2 simultaneously forms the rotor of the linear motor. As an alternative, at least one of the carriages 2 may be operatively coupled to a separately configured rotor of the linear motor.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-13. (canceled)

14. A suspension system for at least one vertically oriented panel having at least two carriages configured to be movable along a travel path, the suspension system comprising:
a running rail having a running surface, the running rail configured to extend along at least one portion of the travel path of the at least one movable panel and the running surface of the running rail configured to point in a direction parallel to the vertical extension of the at least one movable panel;
at least one roller rotatably coupled to each carriage of the at least two carriages such that an axis of rotation of at least one roller extends transversely to the travel path and transversely to a vertical extension of the at least one movable panel, the roller arranged to roll on the running surface of the running rail of the suspension system;
a clamp mounting provided for the each carriage, the clamp mounting configured as an open U having a U-shaped profile, the open U facing the respective movable panel and in which the at least one movable panel is stationarily received, the clamp mounting further comprising:
a clamping jaw configured to be moveably adjusted by an adjusting screw towards and away from the associated movable panel, the screw comprising an end facing away from a head of the screw and supported at the respective clamping jaw, the screw being configured to be screwed into a female thread section of a leg of the U-shaped profile of the open U, which leg is disposed at a side of the movable panel at which the clamping jaw is disposed, the respective movable panel being clamped between the clamping jaw and another leg of the each carriage; and
a projection arranged on the leg of the U-shaped profile which extends from a free end of the leg towards the movable panel, wherein the screw is screwed in a contact member that has an oblique surface at a side facing the movable panel and is configured slanted in the direction of the head of the screw,
whereby the contact member is tapered towards the head of the screw and the clamping jaw, at a side facing the contact member, has an oblique surface configured complementary to the oblique surface of the contact member with which the clamping jaw comes to bear against the oblique surface of the contact member.

15. The suspension system according to claim 14, wherein the at least two carriages of the at least one movable panel are configured such that a vertical central line of each roller coincides respectively with a vertical central line of the at least one moveable panel.

16. The suspension system according to claim 15, further comprising a floor guide, comprising a floor rail configured to receive and support a bottom of the at least one movable panel.

17. The suspension system according to claim 16, wherein the floor guide comprises a carriage in which at least one guiding roller is rotatably disposed, the at least one guiding roller is configured to roll at an inner surface of the floor rail.

18. The suspension system according to claim 17, wherein an axis of rotation of the at least one guiding roller extends parallel to the vertical extension of the at least one movable panel.

19. The suspension system according to claim 18, comprising at least two guiding rollers, wherein the at least two guiding rollers are disposed to roll at opposite inner surfaces of the floor rail.

20. The suspension system according to claim 14, wherein the running surface of the running rail is uneven and the rollers rolling thereon have a running surface configured complementary to the uneven shaped running surface.

21. The suspension system according claim 14, further comprising a contact section that extends parallel to the running rail and is configured, such that the rollers that roll on the running rail are supported at the contact section at a surface facing the respective associated carriage.

22. The suspension system according to claim 14, wherein, from an exterior side of the projection, the screw passes through a vertically extending through-opening of the projection and is screwed into a female thread in the contact member.

23. The suspension system according to claim 22, wherein the oblique surface of the contact member is configured slanted in the direction of the head of the screw such that the contact member tapers towards the head of the screw.

24. The suspension system according to claim 23, wherein the oblique surface of the clamping jaw is configured slanted in the direction of the head of the screw such that the clamping jaw tapers towards the head of the screw.

25. The suspension system according to claim 14, further comprising a linear drive.

26. The suspension system according to claim 14, wherein the at least one movable panel is one of a sliding door leaf, a circular sliding door leaf, a curved sliding door leaf, a folding door leaf, and a revolving door leaf.

27. The suspension system according to claim 16, wherein the floor guide further comprises at least one brush.
